(19) United States
(12) Patent Application Publication
(10) Pub. No.: US 2006/0108715 A1
(43) Pub. Date: May 25, 2006

(54) Method for making a decorative ring of a ceiling fan

(76) Inventor: Yu-Keng Huang, Tucheng City (TW)

Correspondence Address: Yu-Keng Huang, P.O. Box No. 6-57, Junghe, Taipei, 235, TW

(21) Appl. No.: 10/994,381

(22) Filed: Nov. 23, 2004

(51) Int. Cl. B29C 45/14

(52) U.S. Cl. 264/492; 264/138; 264/259; 264/156

(57) ABSTRACT

A method for making a decorative ring of a ceiling fan includes steps of providing a film with a plurality of fixing holes defined therein and a desired pattern printed thereon, drying the film, finalizing the design of the film in accordance with a desired shape and size, cutting the film in accordance with the desired shape and size for forming a desired film, placing the desired film in a mold of an injection machine, and then injecting material to the mold through the injection machine for forming a decorative ring of a ceiling fan.

### BACKGROUND OF THE INVENTION

(a) Field of the Invention

The present invention relates to a method for making a decorative ring of a ceiling fan, and particularly to a method for making a decorative ring of a ceiling fan which is simplified and reduces environmental pollution.

(b) Description of the Prior Art

A conventional method for making a decorative ring of a ceiling fan includes steps of providing a basis material made of metal or plastic with a desired size and shape through first machining, and printing a desired pattern on a surface of the basis material through second machining including plating, spray-painting, baking finish, and thermal transferring.

The decorative ring of the ceiling fan is made through the above conventional method. However, it is complicated to make the decorative ring of the ceiling fan due to the twice machining. Furthermore, it results in environmental pollution such as water pollution, air pollution and heavy metal pollution due to the plating, the spray-painting, the baking finish and the thermal transferring. Therefore, it is required to improve the conventional method for making a decorative ring of a ceiling fan.

### SUMMARY OF THE INVENTION

Accordingly, an object of the present invention is to provide a method for making a decorative ring of a ceiling fan which is simplified.

Another object of the present invention is to provide a method for making a decorative ring of a ceiling fan which reduces environmental pollution.

To achieve the above-mentioned objects, a method for making a decorative ring of a ceiling fan in accordance with the present invention includes steps of providing a film with a plurality of fixing holes defined therein and a desired pattern printed thereon, drying the film, finalizing the design of the film in accordance with a desired shape and size, cutting the film in accordance with the desired shape and size for forming a desired film, placing the desired film in a mold of an injection machine, and then injecting material to the mold through the injection machine for forming a decorative ring of a ceiling fan.

Other objects, advantages and novel features of the present invention will be drawn from the following detailed embodiment of the present invention with attached drawings, in which:

### BRIEF DESCRIPTION OF THE DRAWINGS

FIG. 1 is a flow chart of a method for making a decorative ring of a ceiling fan of the present invention;

FIG. 2 is a schematic view showing a step of punching a film through a punching machine;

FIG. 3 is a schematic view showing a step of drying the film through a drying machine;

FIG. 4 is a schematic view showing a step of finalizing the design of the film through a high pressure molding machine;

FIG. 5 is a schematic view showing a step of cutting the film; and

FIG. 6 is a schematic view showing a step of placing the film in a mold of an injection machine.

### DETAILED DESCRIPTION OF THE PREFERRED EMBODIMENT

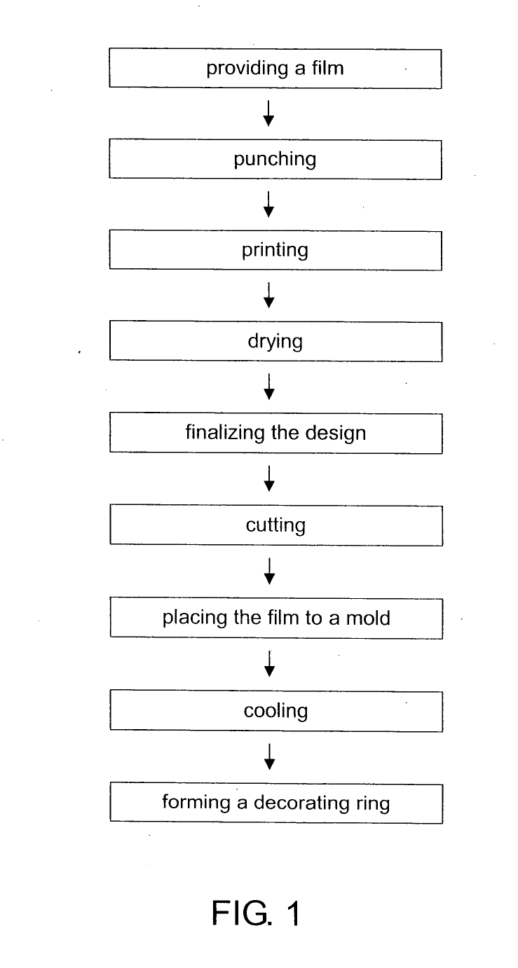

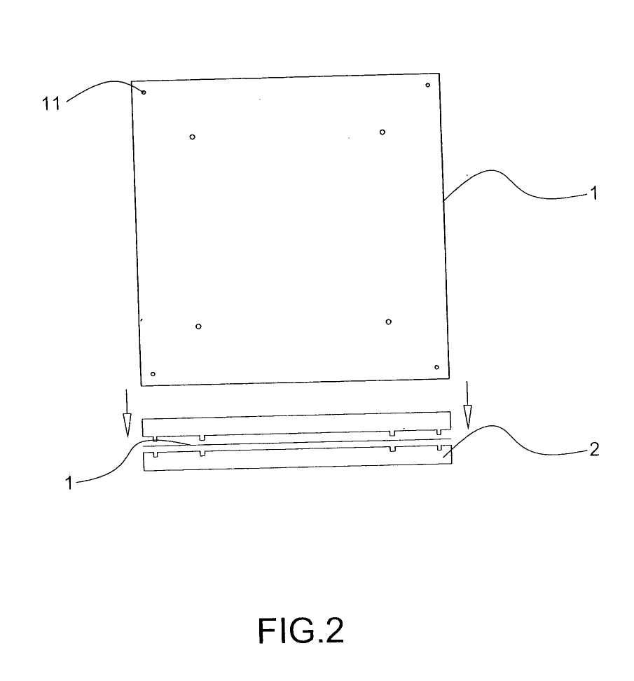

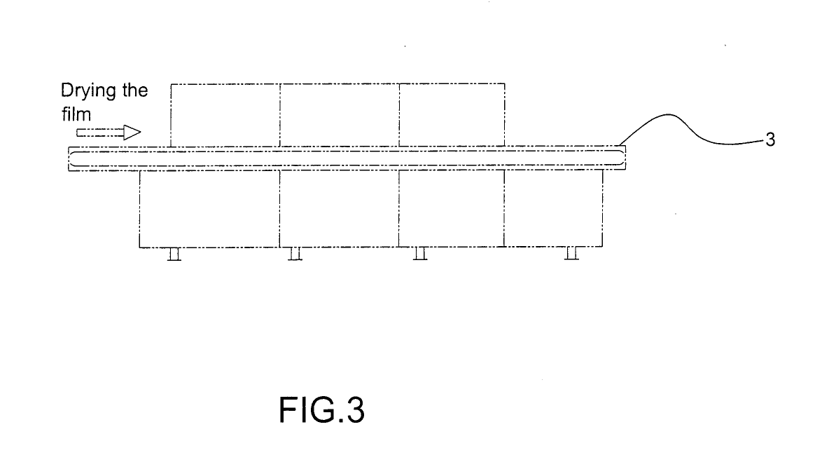

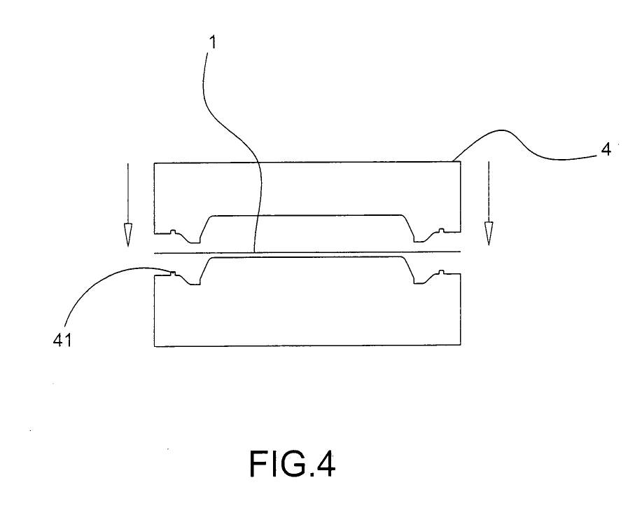

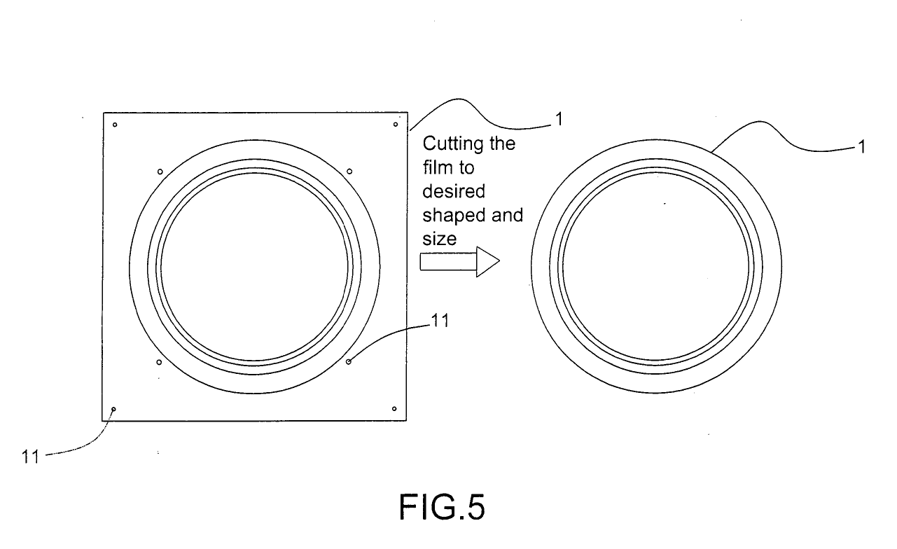

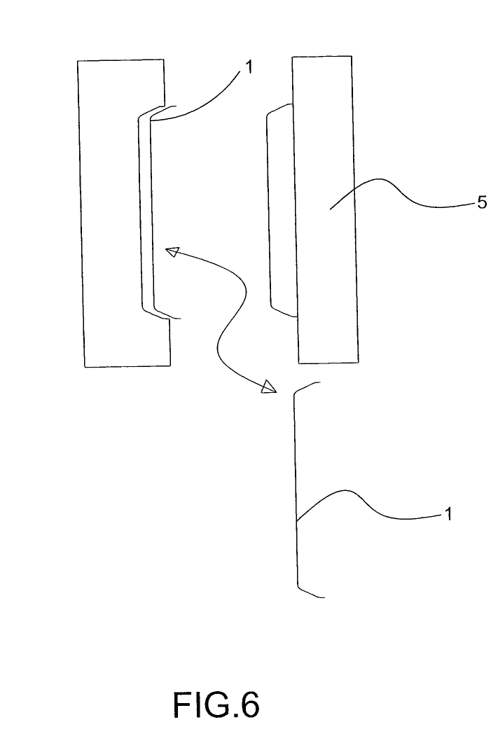

Referring to FIGS. 1-6, a method for making a decorative ring of a ceiling fan of the present invention which is simplified and reduces environmental pollution, includes the following steps:

a. providing a film 1 which may be made of Polyethylcne terephalate (PET) or poly carbonate (PC), punching the film 1 through a punching machine 2 for defining a plurality of fixing holes 11 at a predetermined position printing a desired pattern on the film 1 through half-tone screen (millimicron precision printing);

b. drying the film 1 printed with the pattern through an infrared drying machine 3;

c. finalizing the design of the film 1 in accordance with a desired shape and size through a high pressure molding machine 4 which has a plurality of positioning posts 41 corresponding to the fixing holes 11 of the film 1;

d. cutting the film 1 in accordance with the desired shape and size for providing a desired film 1 with the desired shape and size;

e. placing the desired film 1 in a mold of an injection machine 5, injecting Acrylonitrile Butadiene Styrene (ABS) into the mold through the injection machine 5, cooling the mold and the injected ABS in the mold, thereby forming an ABS decorative ring of a ceiling fan.

Alternatively, after step c, the finalized film 1 may be placed in the mold of the injection machine 5 for forming a decorative ring through the injection machine 5 and then the decorative ring is cut in accordance with the desired shape and size to form the desired decorative ring of the ceiling fan.

Of cause, the method of making a decorative ring of a ceiling fan of the present invention may be applied to make an enclosure of a mobile phone and so on.

Thus, the present invention provides a simplified method for making a decorative ring of a ceiling fan which overcomes the shortcomings of the conventional method for making a decorative ring of a ceiling fan.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A method for making a decorative ring of a ceiling fan, comprising the following steps:
providing a film with a plurality of fixing holes defined therein and a desired pattern printed thereon;
drying the film;
finalizing the design of the film in accordance with a desired shape and size;
cutting the film in accordance with the desired shape and size for forming a desired film;
placing the desired film in a mold of an injection machine, and then injecting material to the mold through the injection machine for forming a decorative ring of a ceiling fan.

2. The method for making a decorative ring of a ceiling fan as claimed in claim 1, wherein the film is made of poly carbonate.

3. The method for making a decorative ring of a ceiling fan as claimed in claim 1, wherein the film is punched to define the fixing holes through a punching machine.

4. The method for making a decorative ring of a ceiling fan as claimed in claim 1, wherein the film is made of Polyethylcne terephalate.

5. The method for making a decorative ring of a ceiling fan as claimed in claim 1, wherein the pattern is printed on the film through half-tone screen.

6. The method for making a decorative ring of a ceiling fan as claimed in claim 1, wherein the film is dried through an infrared drying machine.

7. The method for making a decorative ring of a ceiling fan as claimed in claim 1, wherein the design of the film is finalized through a high pressure molding machine which has a plurality of positioning posts corresponding to the fixing holes of the film.

8. The method for making a decorative ring of a ceiling fan as claimed in claim 1, wherein the material injected into the mold through the injection machine is Acrylonitrile Butadiene Styrene.

9. The method for making a decorative ring of a ceiling fan as claimed in claim 1, wherein after step c, the finalized film is placed in the mold of the injection machine for forming a decorative ring through the injection machine and then the decorative ring is cut in accordance with the desired shape and size to form the desired decorative ring of the ceiling fan.
